(19) United States
(12) Patent Application Publication
(10) Pub. No.: US 2021/0333395 A1
(43) Pub. Date: Oct. 28, 2021

(54) RANGING DEVICE

(71) Applicant: SZ DJI TECHNOLOGY CO., LTD., Shenzhen (CN)

(72) Inventors: Jingyang WU, Shenzhen (CN); Jiachao ZHANG, Shenzhen (CN)

(21) Appl. No.: 17/371,805

(22) Filed: Jul. 9, 2021

Related U.S. Application Data
(63) Continuation of application No. PCT/CN2019/071040, filed on Jan. 9, 2019.

(51) Int. Cl. G01S 17/26; G01S 7/481; G01S 7/484; G01S 7/4861

(52) U.S. Cl. CPC G01S 17/26; G01S 7/4861; G01S 7/484; G01S 7/4813

(57) ABSTRACT

Ranging device includes a transmission assembly configured to emit an optical pulse sequence; a reception assembly configured to receive at least part of the optical pulse sequence reflected back by an object; an optical path changing element configured to combine transmitting optical path of the transmission assembly and reception optical path of the reception assembly; a collimation element configured to collimate transmitting light beam of the transmission assembly and converge the at least part of the optical pulse sequence reflected back by the object to the reception assembly; and a fixing assembly configured to fix the transmission assembly, the reception assembly, the optical path changing element, and the collimation element to each other.

### CROSS-REFERENCE TO RELATED APPLICATION

This application is a continuation of International Application No. PCT/CN2019/071040, filed Jan. 9, 2019, the entire content of which is incorporated herein by reference.

### TECHNICAL FIELD

The present disclosure relates to the technical field of ranging and, more particularly, to a ranging device.

### BACKGROUND

Laser radar and laser ranging are perception systems to outside world, which can obtain spatial distance information in emitting direction. The principle is to actively transmit a laser pulse signal to outside, detect a reflected pulse signal, and determine distance of a measured object according to time difference between transmission and reception. Transmission/reception elements of a laser ranging device are the core optoelectronic devices in a ranging module. At present, the transmission/reception elements are fixed by screws in assembly of a ranging device. Due to manufacturing error of the laser ranging device and related parts (mainly caused by mechanical processing, parts assembly, circuit board welding, etc.), there is always deviation or deflection between actual transmission/reception elements and ideal optical position, and it is needed to adjust spatial position and attitude of multiple degrees of freedom to further ensure that the transmission/reception elements are in more reasonable optical position. The conventional method uses screws to fix, on one hand, it is difficult to realize adjustment of multiple degrees of freedom in a limited space, so that performance consistency of the laser ranging device is difficult to guarantee; on the other hand, under working conditions such as temperature change and vibration, there is also risk of failure of threaded fasteners in a single screw fixation.

### SUMMARY

In accordance with the disclosure, there is provided a ranging device, including a transmission assembly configured to emit an optical pulse sequence; a reception assembly configured to receive at least part of the optical pulse sequence reflected back by an object; an optical path changing element configured to combine transmitting optical path of the transmission assembly and reception optical path of the reception assembly; a collimation element configured to collimate transmitting light beam of the transmission assembly and converge the at least part of the optical pulse sequence reflected back by the object to the reception assembly; and a fixing assembly configured to fix the transmission assembly, the reception assembly, the optical path changing element, and the collimation element to each other. The transmission assembly and/or the reception assembly, and the fixing assembly are fixed to each other in at least a first fixing mode and a second fixing mode, a fixed speed in the first fixing mode being higher than that in the second fixing mode, and a fixed strength in the second fixing mode being higher than that in the first fixing mode.

### BRIEF DESCRIPTION OF THE DRAWINGS

In order to explain the embodiments of the present disclosure more clearly, reference is made to the accompanying drawings, which are used in the description of the embodiments or the existing technology. Obviously, the drawings in the following description are some embodiments of the present disclosure, and other drawings can be obtained from these drawings without any inventive effort for those of ordinary skill in the art.

FIG. 1 illustrates a ranging device according to an embodiment of the present disclosure.

FIG. 2 illustrates an example of a first fixing mode according to an embodiment of the present disclosure.

FIG. 3 illustrates another example of a first fixing mode according to an embodiment of the present disclosure.

FIG. 4 illustrates another example of a first fixing mode according to an embodiment of the present disclosure.

FIG. 5 illustrates another example of a first fixing mode according to an embodiment of the present disclosure.

FIG. 6 illustrates a combination example of an example of a first fixing mode and a second fixing mode according to an embodiment of the present disclosure.

FIG. 7 illustrates a combination example of another example of a first fixing mode and a second fixing mode according to an embodiment of the present disclosure.

FIG. 8 illustrates a combination example of another example of a first fixing mode and a second fixing mode according to an embodiment of the present disclosure.

FIG. 9 illustrates an example of a second fixing mode according to an embodiment of the present disclosure.

FIG. 10 illustrates another example of a first fixing mode according to an embodiment of the present disclosure.

FIG. 11 is a schematic structural diagram showing an example between a transmission assembly and/or a reception assembly and a fixing assembly according to an embodiment of the present disclosure.

FIG. 12 is a schematic structural diagram showing an example between a transmission assembly and/or a reception assembly and a fixing assembly according to an embodiment of the present disclosure.

FIG. 13 is a schematic structural diagram showing an example between a transmission assembly and/or a reception assembly and a fixing assembly according to an embodiment of the present disclosure.

FIG. 14 is a schematic diagram showing a flexible connection according to an embodiment of the present disclosure.

FIG. 15 illustrates an example of an initial state of pins of a transmission element and/or a reception element according to an embodiment of the present disclosure.

FIG. 16 illustrates an example of a flexible connection according to an embodiment of the present disclosure.

FIG. 17 illustrates another example of an initial state of pins of a transmission element and/or a reception element according to an embodiment of the present disclosure.

FIG. 18 illustrates another example of a flexible connection according to an embodiment of the present disclosure.

FIG. 19 illustrates another example of a flexible connection according to an embodiment of the present disclosure.

FIG. 20 is a schematic structural block diagram of a ranging device according to an embodiment of the present disclosure.

FIG. 21 is a schematic diagram showing an embodiment in which a ranging device employs a coaxial optical path according to the present disclosure.

### DETAILED DESCRIPTION OF THE EMBODIMENTS

The technical solutions in the embodiments of the present disclosure will be described in detail with reference to the accompanying drawings. Obviously, the described embodiments are only some of rather than all the embodiments of the present disclosure. Based on the described embodiments, all other embodiments obtained by those of ordinary skill in the art without inventive effort shall fall within the scope of the present disclosure.

During assembly process of a laser ranging device, it is needed to adjust transmission elements and reception elements to corresponding optical positions (usually near focal points of lens) in proper postures in space, forming an effective circuit connection with system circuit, and achieving a reliable structure fixation, so as to ensure that the laser ranging device has sufficient detection distance and detection precision during operation.

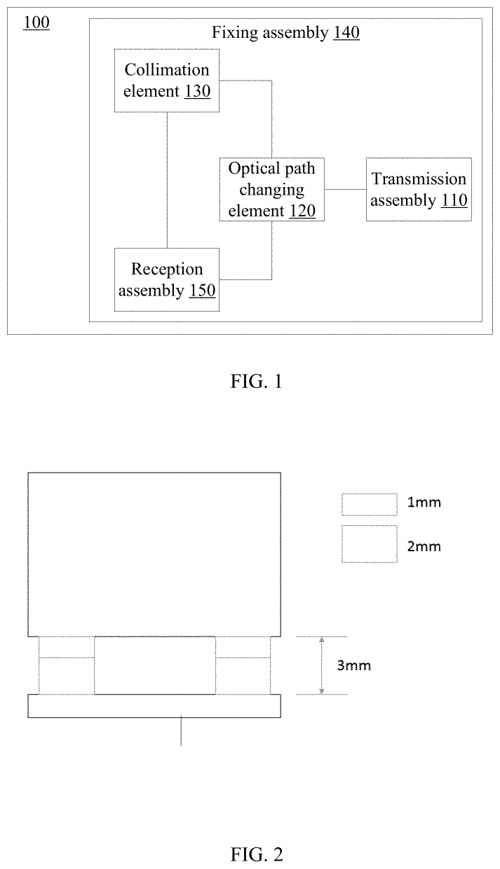

Based on considerations described above, the embodiments of the present disclosure provide a ranging device. FIG. 1 illustrates a ranging device 100 according to an embodiment of the present disclosure. The ranging device 100 includes: a transmission assembly 110, an optical path changing element 120, a collimation element 130, a fixing assembly 140, and a reception assembly 150. The transmission assembly 110 is configured to emit an optical pulse sequence. The reception assembly 150 is configured to receive at least part of the optical pulse sequence reflected back by an object. The optical path changing element 120 is configured to combine transmitting optical path of the transmission assembly 110 and reception optical path of the reception assembly 150. The collimation element 130 is configured to collimate transmitting light beam of the transmission assembly 110 and converge at least part of the optical pulse sequence reflected back by the object to the reception assembly. The fixing assembly 140 is configured to fix the transmission assembly 110, the reception assembly 150, the optical path changing element 120, and the collimation element 130 to each other. The transmission assembly 110 and/or the reception assembly 150 and the fixing assembly are fixed to each other in at least a first fixing mode and a second fixing mode. A fixed speed in the first fixing mode is higher than that in the second fixing mode, and a fixed strength in the second fixing mode is higher than that in the first fixing mode.

The first fixing mode can quickly fix the transmission assembly and/or the reception assembly, and the fixing assembly to each other, and the second fixing mode can firmly fix the transmission assembly and/or the reception assembly to the fixing assembly. By combining these two fixing modes, reliable structural fixation can be achieved under any working conditions, so as to guarantee detection distance and detection precision of the ranging device.

The first fixing mode refers to that the transmission assembly, the optical path changing element, the collimation element, the reception assembly, and the fixing assembly are reliably fixed at a specific position of the laser ranging device, so that the transmission assembly, the optical path changing element, the collimation element, the reception assembly, and the fixing assembly cannot be separated or moved from each other in a working state.

For example, the transmission assembly and/or the reception assembly, and the fixing assembly are fixed to each other in the first fixing mode, which includes that at least one gasket is arranged between the transmission assembly and/or the reception assembly, and the fixing assembly, and the transmission assembly and/or the reception assembly, the fixing assembly, and the at least one gasket are fixed to each other by screws.

FIG. 2 illustrates an example in the first fixing mode according to an embodiment of the present disclosure. As shown in FIG. 2, there is a 3 mm gap between the transmission assembly and/or the reception assembly, and the fixing assembly. Gaskets with suitable sizes are selected and arranged in the 3 mm gap, and then the transmission assembly and/or the reception assembly, the fixing assembly, and the gaskets are fixed to each other by screws. Specifically, position between the transmission assembly and/or the reception assembly, and the fixing assembly is adjusted to a suitable position; gap size between the transmission assembly and/or the reception assembly, and the fixing assembly is obtained by measurement, and the transmission assembly and/or the reception assembly are provided with screw mounting holes; then gaskets are selected or combined in a series of gaskets with fixed thickness to form a thickness corresponding to the gap size, such as 1 mm gasket and 2 mm gasket are combined with a 3 mm thickness to fill the actual gap, which are arranged between the transmission assembly and/or the reception assembly, and the fixing assembly; finally the transmission assembly and/or the reception assembly, the gaskets, and the fixing assembly are connected tightly by screws to achieve fixation. Also, the thinner thickness of the gaskets, and the more specifications of the gaskets, thickness dimension that can be combined is more accurate.

For example, the transmission assembly and/or the reception assembly, and the fixing assembly are fixed to each other in the first fixing mode, which includes that movable clamping jaws are arranged at the fixing assembly, and the movable clamping jaws clamp the transmission assembly and/or the reception assembly.

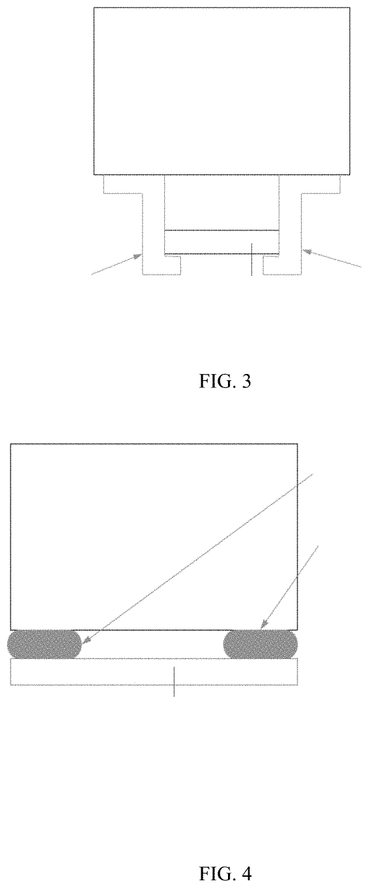

FIG. 3 illustrates another example in the first fixing mode according to an embodiment of the present disclosure. As shown in FIG. 3, the fixing assembly is provided with movable clamping jaws (including a movable clamping jaw 1 and a movable clamping jaw 2), which can realize at least one of horizontal movement, vertical movement, or rotation at the fixing assembly. The movable clamping jaws clamp the transmission assembly and/or the reception assembly, and adjust the transmission assembly and/or the reception assembly to corresponding position, that is, complete the fixing of the transmission assembly and/or the reception assembly, and the fixing assembly. It should be noted that the movable clamping jaws mainly use friction to clamp the transmission assembly and/or the reception assembly, and if the friction between the movable clamping jaws and the transmission assembly and/or the reception assembly are insufficient, surface treatment or bonding of high friction materials to the movable clamping jaws can be used to increase the friction between the movable clamping jaws and other components such as the transmission assembly and/or the reception assembly, so that reliability of fixation is further ensured. Moreover, the first fixing mode in some embodiments also enables more freely position adjustment of the transmission assembly and/or the reception assembly.

For example, the transmission assembly and/or the reception assembly, and the fixing assembly are fixed to each other in the first fixing mode, which includes that at least part of the gap between the transmission assembly and/or the reception assembly, and the fixing assembly is filled with a fixed structural adhesive to fix each other.

For example, there is a gap between the transmission assembly and/or the reception assembly, and the fixing assembly.

FIG. 4 illustrates another example in the first fixing mode according to an embodiment of the present disclosure. As shown in FIG. 4, after distance between the transmission assembly and/or the reception assembly, and the fixing assembly is adjusted to a suitable position, at least part of the gap between the transmission assembly and/or the reception assembly, and the fixing assembly is filled a fixed structural adhesive with a certain viscosity. After the adhesive is cured, the fixing between the transmission assembly and/or the reception assembly, and the fixing assembly is completed, and it is ensured that the fixed structural adhesive will not be lost from the gap during the curing process. Edge of the gap between the transmission assembly and/or the reception assembly, and the fixing assembly is filled with the fixed structural adhesive, so that the transmission assembly and/or the reception assembly, and the fixing assembly are fixed to each other. In this manner, not only a reliable connection is realized, but also adjustment range and freedom between the transmission assembly and/or the reception assembly, and the fixing assembly are further increased. In addition, dispensing operation is also simpler and more efficient than mechanical connection operation.

For example, the transmission assembly and/or the reception assembly, and the fixing assembly are fixed to each other in the first fixing mode, which includes that the fixing assembly has protruding structures arranged in openings of the transmission assembly and/or the reception assembly, and at least part of the gap between the protruding structures and the openings is filled with the fixed structural adhesive.

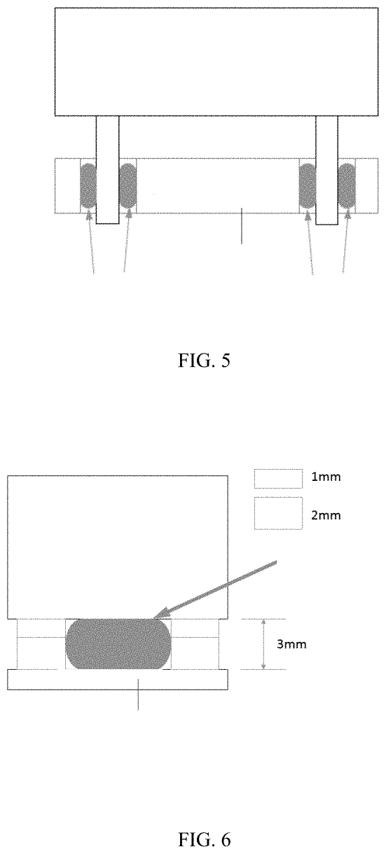

FIG. 5 illustrates another example in the first fixing mode according to an embodiment of the present disclosure. As shown in FIG. 5, the fixing assembly includes protruding structures, and openings are provided at the transmission assembly and/or the reception assembly. The protruding structures of the fixing assembly are inserted into the openings, and the gap between the protruding structures and the openings is filled with the fixed structural adhesive, so that the transmission assembly and/or the reception assembly, and the fixing assembly are reliably fixed.

The second fixing mode refers to that a layer of reinforced structural adhesive with excellent performance (such as good thermal stability and high mechanical strength) is smeared or filled between the transmission assembly and/or the reception assembly, and the fixing assembly, and after curing, the reinforced structural adhesive can ensure good performance of the laser ranging device under different working conditions. If the working conditions of a product put forward more stringent requirements on the fixed strength of the transmission assembly and/or the reception assembly, it may be considered to use structural adhesive that meets the requirements of the working condition for further reinforcement after the fixing is completed. For example, structural adhesive can be filled for reinforcement as long as there is a gap between the transmission assembly and/or the reception assembly, and the fixing assembly, and the structural adhesive for reinforcement can be of different models from the structural adhesive for fixing.

For example, the transmission assembly and/or the reception assembly, and the fixing assembly are fixed to each other in the second fixing mode, which includes that the transmission assembly and/or the reception assembly, and the fixing assembly are fixed to each other by the reinforced structural adhesive.

For example, the transmission assembly and/or the reception assembly, and the fixing assembly are fixed to each other in the second fixing mode, which includes that, on the basis in the first fixing mode, a remaining gap in the space between the transmission assembly and/or the reception assembly, and the fixing assembly is filled by the reinforced structural adhesive.

For example, the transmission assembly and/or the reception assembly, and the fixing assembly are fixed to each other by the reinforced structural adhesive, which includes that at least part of the gap in the space between the transmission assembly and/or the reception assembly, and the fixing assembly is filled by the reinforced structural adhesive.

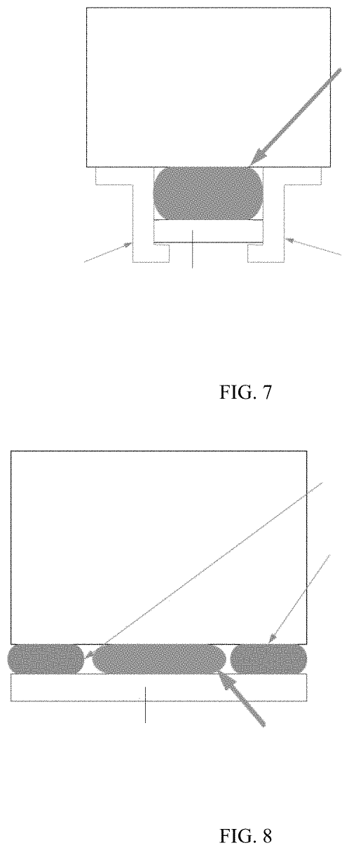

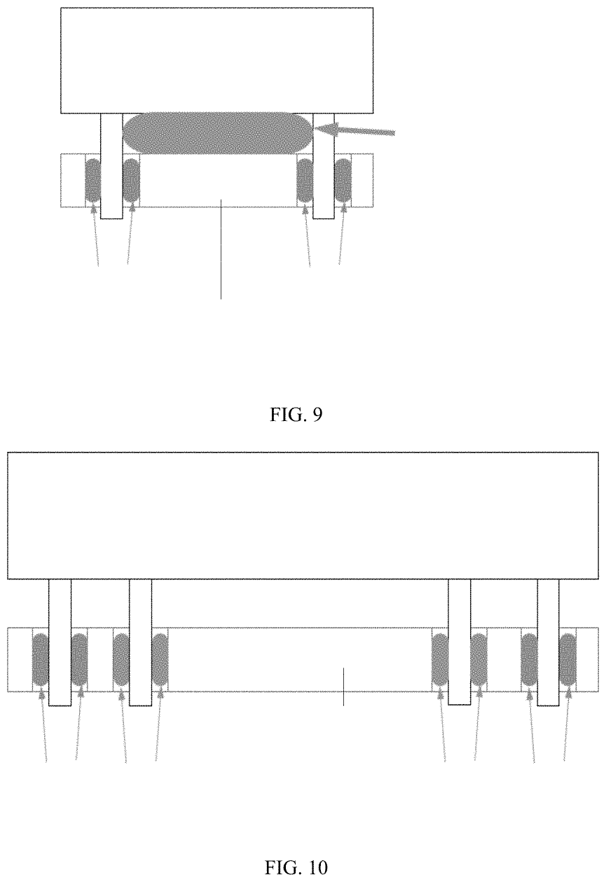

Referring to FIGS. 6-8, FIG. 6 illustrates a combination example of an example in the first fixing mode and the second fixing mode according to an embodiment of the present disclosure, in which the reinforced structural adhesive is used to fill a gap between the gaskets; FIG. 7 illustrates a combination example of another example in the first fixing mode and the second fixing mode according to an embodiment of the present disclosure, in which the reinforced structural adhesive is used to fill a space formed between the transmission assembly and/or the reception assembly, the fixing assembly, and the movable clamping jaws; FIG. 8 illustrates a combination example of another example in the first fixing mode and the second fixing mode according to an embodiment of the present disclosure, in which the reinforced structural adhesive is used to fill a gap between the fixed structural adhesive.

In some embodiments, reference can be made to FIG. 9, which illustrates an example in the second fixing mode according to an embodiment of the present disclosure. As shown in FIG. 9, the transmission assembly and/or the reception assembly, and the fixing assembly are fixed to each other by the reinforced structural adhesive, which includes that: the fixing assembly has protruding structures, the transmission assembly and/or the reception assembly has openings; the protruding structures are inserted into the openings, and gaps between the protruding structures and the openings are filled by the structural adhesive; at least part of the gaps in the space between the transmission assembly and/or the reception assembly, and the fixing assembly are filled by the reinforced structural adhesive.

In some embodiments, reference can be made to FIG. 10, which illustrates another example in the second fixing mode according to an embodiment of the present disclosure. As shown in FIG. 10, the transmission assembly and/or the reception assembly, and the fixing assembly are fixed to each other by the reinforced structural adhesive, which includes that: the fixing assembly has protruding structures, a circuit board in the transmission assembly and/or the reception assembly has openings; the protruding structures are inserted into the openings, and gaps between the protruding structures and at least part of the openings are filled by the structural adhesive; gaps between the protruding structures and at least part of the openings are filled by the reinforced structural adhesive.

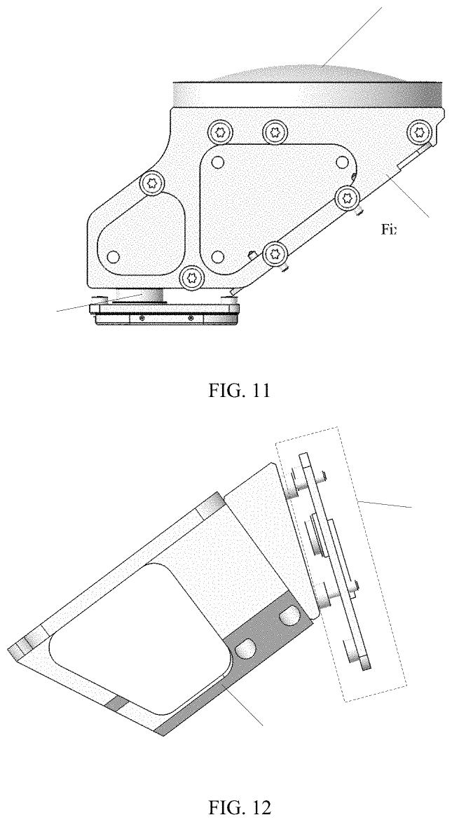

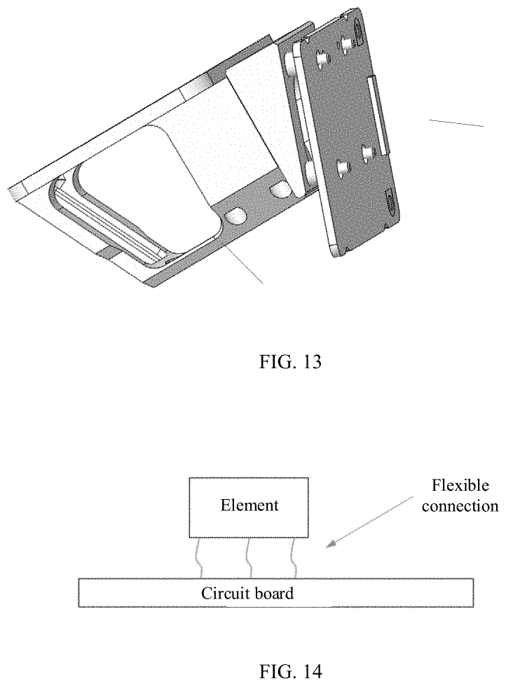

In some embodiments, reference can be made to FIGS. 11-13, which show schematic structural diagrams between the transmission assembly and/or the reception assembly, and the fixing assembly according to the embodiments of the present disclosure.

For example, the reinforced structural adhesive can be gypsum, and can also be a high temperature resistant inorganic glue.

For example, the transmission assembly includes transmission elements electrically coupled to a transmission circuit board, and the reception assembly includes reception elements electrically coupled to a reception circuit board.

Electrical coupling refers to an effective circuit connection formed by the transmission assembly and/or the reception assembly and an overall circuit system. The electrical coupling includes a fixed connection or a flexible connection.

For example, the transmission assembly includes a fixed connection or a flexible connection between the transmission element and the transmission circuit board; and/or the reception assembly includes a fixed connection or a flexible connection between the reception element and the reception circuit board.

For example, the fixed connection includes that: pins of the transmission element and the transmission circuit board are fixedly welded; and/or pins of the reception element and the reception circuit board are fixedly welded.

The fixed connection welds the transmission element and/or the reception element to the transmission circuit board and/or the reception circuit board to form the transmission assembly and/or the reception assembly. By a manner of fixing the entire transmission assembly and/or the reception assembly after adjusting positions of the entire transmission assembly and/or the reception assembly and the fixing assembly, a joint fixing of the transmission element and/or the reception element and the transmission circuit board and/or the reception circuit board can be realized. After that, as long as the transmission circuit board and/or the reception circuit board form an effective circuit connection with the overall circuit system, the element forms an effective circuit connection with the overall circuit system. The transmission element and/or the reception element are welded on the transmission circuit board and/or the reception circuit board. When positions of the transmission circuit board and/or the reception circuit board are fixed, positions of the transmission element and/or the reception element are also fixed.

A flexible connection refers to that the fixing between the transmission element and/or the reception element and the transmission circuit board and/or the reception circuit board is independent and does not affect each other, but is effectively interconnected on the circuit ultimately. Reference can be made to FIG. 14, which is a schematic diagram showing a flexible connection according to an embodiment of the present disclosure.

The flexible connection can also be that the transmission element and/or the reception element and the transmission circuit board and/or the reception circuit board are not welded first, and after the position adjustment between the transmission element and/or the reception element and the transmission circuit board and/or the reception circuit board is completed, the transmission element and/or the reception element and the transmission circuit board and/or the reception circuit board are respectively fixed, for example, the transmission element and/or the reception element are fixed first, and then the transmission circuit board and/or the reception circuit board are fixed separately. The transmission element and/or the reception element can form a flexible effective circuit connection with the transmission circuit board and/or the reception circuit board and the overall circuit system through pin contact, pin welding, pin welding extension line (wire) or another manner.

For example, the pins of the transmission assembly and/or the reception assembly include flexible materials, and the flexible connection includes that: the pins of the transmission assembly are in elastic contact with metalized holes of the transmission circuit board; and/or, the pins of the reception assembly are in elastic contact with metalized holes of the reception circuit board.

The pins of the transmission element and/or the reception element are made of soft conductive materials with sufficient length. After the pins penetrate the corresponding metalized holes of the transmission circuit board and/or the reception circuit board, there is a certain gap between the transmission element and/or the reception element and the transmission circuit board and/or the reception circuit board, so that the transmission element and/or the reception element can move freely relative to the transmission circuit board and/or the reception circuit board within a certain range.

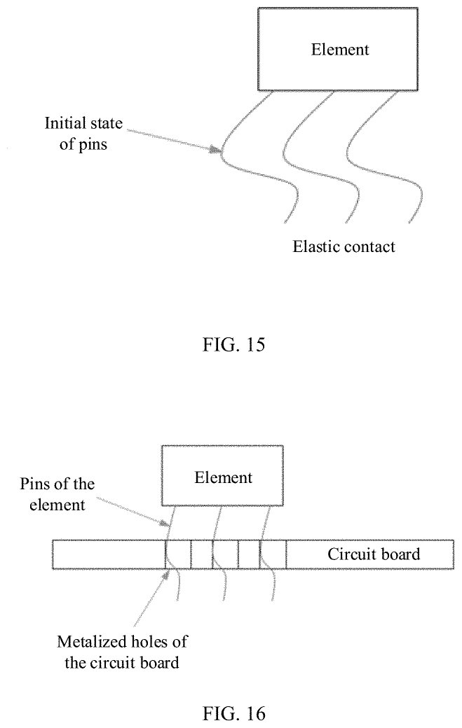

The transmission element and/or the reception element and the transmission circuit board and/or the reception circuit board are fixed separately after they are adjusted to the suitable positions. If the pins have a certain elasticity and enter the metalized holes in a bent initial state, after squeezed by the metalized holes, they will naturally come into direct contact with the metalized holes under action of resilience force, forming an effective circuit connection in a form of “elastic contact”. FIG. 15 illustrates an example of the initial state of the pins of the transmission element and/or the reception element according to an embodiment of the present disclosure, and FIG. 16 illustrates an example of the flexible connection according to an embodiment of the present disclosure.

For example, the pins of the transmission assembly and/or the reception assembly include flexible materials, and the flexible connection includes that: the pins or pin extension wires of the transmission assembly and the metalized holes of the transmission circuit board are welded; and/or, the pins or pin extension wires of the reception assembly and the metalized holes of the reception circuit board are welded.

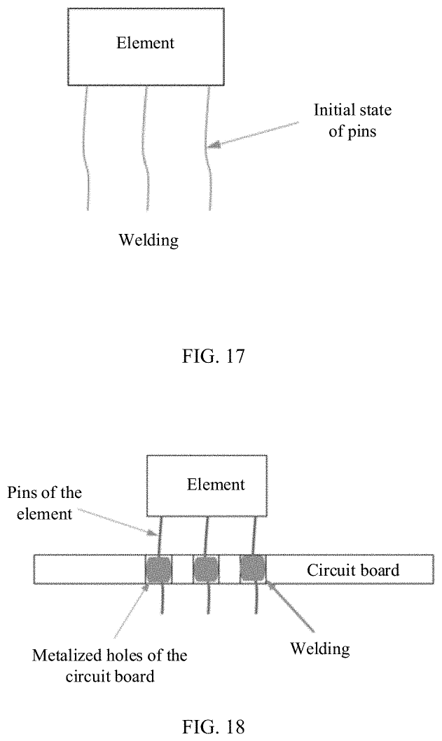

If the elasticity of the pins of the transmission assembly and/or the reception assembly is not considered, after the pins of the transmission assembly and/or the reception assembly enter the metalized hole, welding with solder can also establish the effective circuit connection between the transmission assembly and/or the reception assembly and the transmission circuit board and/or the reception circuit board. FIG. 17 illustrates another example of the initial state of the transmission element and/or the reception element according to an embodiment of the present disclosure. FIG. 18 illustrates another example of the flexible connection according to an embodiment of the present disclosure.

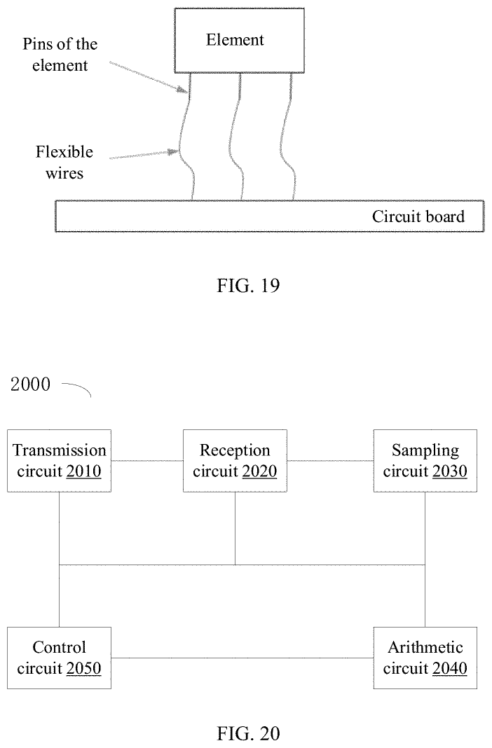

Flexible wires are welded at the end of the pins of the transmission element and/or the reception element as the pin extension wires, which further increases relative movement range of the element and the circuit board. After the transmission element and/or the reception element and the transmission circuit board and/or the reception circuit board are respectively fixed, the flexible wires are welded to the pins of the transmission element and/or the reception element and corresponding welding points of the transmission circuit board and/or the reception circuit board, so as to establish the effective circuit connection between the transmission element and/or the reception element and the transmission circuit board and/or the reception circuit board. Reference can be made to FIG. 19, which illustrates another example of the flexible connection according to an embodiment of the present disclosure.

For example, the collimation element is located at one end of the fixing assembly, and the reception assembly is located at the other end of the fixing assembly. The at least part of the optical pulse sequence reflected back by the object forms an optical path between the transmission assembly and the collimation element.

For example, the collimation element is located at one end of the fixing assembly, and the transmission assembly is located at a side of the fixing assembly.

For example, the optical path changing element is located within the fixing assembly, and the transmission assembly transmits emitted optical pulse sequence to the collimation element within the fixing assembly through the optical path changing element.

Referring back to FIG. 11, as shown in FIG. 11, the collimation element is located at one end of the fixing assembly, and the reception assembly is located at the other end of the fixing assembly. The at least part of the optical pulse sequence reflected back by the object forms an optical path between the reception assembly and the collimation element within the fixing assembly. The reception assembly includes the reception element and the reception circuit board that form an electrical coupling, and the reception circuit board includes four openings. The reception assembly and the fixing assembly are fixed relative to each other through the four openings of the reception assembly and four protruding structures of the fixing assembly, and the four extending structures are inserted into the four openings respectively. Gaps between the four protruding structures and the four openings can be filled with the fixed structural adhesive, and the space between the fixing assembly and the reception assembly can be filled with the reinforced structural adhesive to form reliable fixation. It can also be that part of the gaps between the four protruding structures and the four openings are filled with the fixed structural adhesive, and the remaining are filled with the reinforced structural adhesive to form reliable fixation. The reception assembly (not shown) is located at a side of the fixing assembly, the optical path changing element is located within the fixing assembly, and the transmission assembly transmits the emitted optical pulse sequence to the collimation element within the fixing assembly through the optical path changing element.

The ranging device in the various embodiments of the present disclosure may be an electronic equipment such as a laser radar or a laser ranging equipment. In some embodiments, the ranging device is configured to sense external environment information, such as distance information, orientation information, reflection intensity information, speed information, etc. of an environmental target. In one implementation manner, the ranging device can detect distance of a detected object to the ranging device by measuring time of light propagation, that is, time-of-flight (TOF), between the ranging device and the detected object. The ranging device can also detect the distance from the detected object to the ranging device by other techniques, such as a ranging method based on phase shift measurement or a ranging method based on frequency shift measurement, which is not limited herein.

For better understanding, a ranging workflow will be described with examples in conjunction with a ranging device 2000 shown in FIG. 20.

As shown in FIG. 20, the ranging device 2000 includes a transmission circuit 2010, a reception circuit 2020, a sampling circuit 2030, and an arithmetic circuit 2040.

The transmission circuit 2010 can emit an optical pulse sequence (e.g., a laser pulse sequence). The reception circuit 2020 can receive the optical pulse sequence reflected back by a detected object and perform photoelectric conversion on the optical pulse sequence to obtain an electrical signal, and then the electrical signal is processed and output to the sampling circuit 2030. The sampling circuit 2030 can sample the electrical signal to obtain a sampling result. The arithmetic circuit 2040 can determine distance between the ranging device 2000 and the detected object based on the sampling result of the sampling circuit 2030.

For example, the ranging device 2000 also includes a control circuit 2050, which can control other circuits, for example, can control operation time of each circuit and/or set parameters for each circuit.

It should be noted that although the ranging device shown in FIG. 20 includes a transmission circuit, a reception circuit, a sampling circuit, and an arithmetic circuit configured to emit a light beam for detection, the embodiments of the present disclosure are not limited thereto. Number of any one of the transmission circuit, the reception circuit, the sampling circuit, and the arithmetic circuit may also be at least two, which are configured to emit at least two light beams in same direction or in different directions respectively. The at least two light beams may be emitted simultaneous or may be emitted at different times respectively. In some embodiments, light emitting chips in the at least two transmission circuits are packaged in same module. For example, each transmission circuit includes a laser emitting chip, and dies of the laser emitting chips in the at least two transmission circuits are packaged together and housed in same package space.

In some implementations, in addition to the circuits shown in FIG. 20, the ranging device 2000 may also include a scanning module 2060 for changing propagation direction of at least one optical pulse sequence emitted by the transmission circuit.

A module including the transmission circuit 2010, the reception circuit 2020, the sampling circuit 2030, and the arithmetic circuit 2040, or a module including the transmission circuit 2010, the reception circuit 2020, the sampling circuit 2030, the arithmetic circuit 2040, and the control circuit 2050 may be referred to as a ranging module, which can be independent of other modules, such as the scanning module 2060.

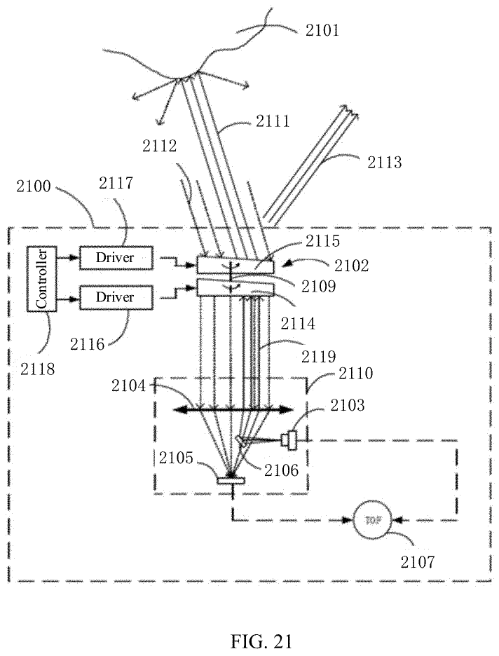

A coaxial optical path can be used in the ranging device, that is, the light beam emitted by the ranging device and the reflected light beam share at least part of the optical path within the ranging device. For example, after at least one laser pulse sequence emitted by the transmission circuit changes its propagation direction and emits through the scanning module, the laser pulse sequence reflected back by the detected object passes through the scanning module and then enters the reception circuit. An off-axis optical path can also be used in the ranging device, that is, the light beam emitted by the ranging device and the reflected light beam are respectively transmitted along different optical paths within the ranging device. FIG. 21 illustrates a schematic diagram of a ranging device using a coaxial optical path according to an embodiment of the present disclosure.

A ranging device 2100 includes a ranging module 2110, which includes a transmitter 2103 (which may include the transmission circuit described above), a collimation element 2104, a detector 2105 (which may include the reception circuit, the sampling circuit, and the arithmetic circuit described above), and an optical path changing element 2106. The ranging module 2110 is configured to emit the light beam, receive the reflected light, and convert the reflected light into the electrical signal. The transmitter 2103 can be configured to emit the light sequence. In some embodiments, the transmitter 2103 may emit the laser pulse sequence. For example, a laser beam emitted by the transmitter 2103 is a narrow-bandwidth beam with a wavelength outside visible light range. The collimation element 2104 is arranged on the transmitting optical path of the transmitter, and is configured to collimate the light beam emitted from the transmitter 2103 and collimate the light beam emitted from the transmitter 2103 into parallel light output to the scanning module. The collimation element is also configured to converge at least part of the reflected light reflected back by the detected object. The collimation element 2104 may be a collimating lens or another element capable of collimating the light beam.

In the embodiments shown in FIG. 21, the transmitting optical path and the reception optical path within the ranging device are merged before the collimation element 2104 by the optical path changing element 2106, so that the transmitting optical path and the reception optical path can share the same collimation element, such as sharing a same transceiver lens, which makes the optical path more compact. In some other implementations, the transmitter 2103 and the detector 2105 may respectively use their own collimation elements, and the optical path changing element 2106 is arranged on the optical path behind the collimation element.

In the embodiment shown in FIG. 21, since beam aperture of the light beam emitted by the transmitter 2103 is small, and beam aperture of the reflected light received by the ranging device is large, the optical path changing element can use a small-area reflector to merge the transmitting optical path and the reception optical path. In some other implementations, the optical path changing element may also use a reflector with a through hole, where the through hole is used to transmit emitted light of the transmitter 2103 and the reflector is used to reflect the reflected light to the detector 2105, which can reduce block of the reflected light from a support of a small reflector in case of using the small reflector.

In the embodiments shown in FIG. 21, the optical path changing element is deviated from an optical axis of the collimation element 2104. In some other implementations, the optical path changing element may also be located on the optical axis of the collimation element 2104.

The ranging device 2100 also includes a scanning module 2102 arranged on the transmitting optical path of the ranging module 2110. The scanning module 2102 is configured to change transmission direction of a collimated light beam 2119 emitted by the collimation element 2104 and project it to external environment. The reflected light is projected to the collimation element 2104, and is converged on the detector 2105 through the collimation element 2104.

In some embodiments, the scanning module 2102 may include at least an optical element for changing propagation path of the light beam, and the optical element may change the propagation path of the light beam by reflecting, refracting, diffracting, etc. For example, the scanning module 2102 includes a lens, a reflector, a prism, a galvanometer, a grating, a liquid crystal, an optical phased array, or any combination of the above. In some embodiments, at least some of the optical elements are movable, for example, the at least some of the optical elements are driven to move by a drive module, and the movable optical element can reflect, refract or diffract the light beam to different directions at different times. In some embodiments, the multiple optical elements of the scanning module 2102 can rotate or vibrate around a common rotation axis 2109, and each rotating or vibrating optical element is configured to continuously change the propagation direction of an incident light beam. In some embodiments, the multiple optical elements of the scanning module 2102 may rotate at different rotation speeds or vibrate at different speeds. In some other embodiments, the at least some of the optical elements of the scanning module 2102 may rotate at substantially the same rotation speed. In some embodiments, the multiple optical elements of the scanning module may also rotate around different axes. In some embodiments, the multiple optical elements of the scanning module may also rotate in the same direction or in different directions; or vibrate in the same direction or in different directions, which is not limited herein.

In some embodiments, the scanning module 2102 includes a first optical element 2114 and a driver 2116 connected to the first optical element 2114. The driver 2116 is configured to drive the first optical element 2114 to rotate around the rotation axis 2109, such that the first optical element 2114 changes the direction of the collimated light beam 2119, and the first optical element 2114 projects the collimated light beam 2119 to different directions. In some embodiments, angle between the direction of the collimated light beam 2119 changed by the first optical element and the rotation axis 2109 varies with the rotation of the first optical element 2114. In some embodiments, the first optical element 2114 includes a pair of opposing non-parallel surfaces through which the collimated light beam 2119 passes. In some embodiments, the first optical element 2114 includes a prism that varies in thickness along at least a radial direction. In some embodiments, the first optical element 2114 includes a wedge angle prism that refracts the collimated light beam 2119.

In some embodiments, the scanning module 2102 also includes a second optical element 2115 that rotates around the rotation axis 2109, and the rotation speed of the second optical element 2115 is different from the rotation speed of the first optical element 2114. The second optical element 2115 is configured to change the direction of the light beam projected by the first optical element 2114. In some embodiments, the second optical element 2115 is connected to another driver 2117 that drives the second optical element 2115 to rotate. The first optical element 2114 and the second optical element 2115 can be driven by the same or different drivers, so that the rotation speed and/or rotation direction of the first optical element 2114 and the second optical element 2115 are different, thereby projecting the collimated light beam 2119 to different directions in outside space, and a larger space can be scanned. In some embodiments, a controller 2118 controls the drivers 2116 and 2117 to drive the first optical element 2114 and the second optical element 2115, respectively. The rotation speeds of the first optical element 2114 and the second optical element 2115 may be determined according to area and pattern expected to be scanned in actual applications. The drivers 2116 and 2117 may include motors or other drivers.

In some embodiments, the second optical element 2115 includes a pair of opposing non-parallel surfaces through which the light beam passes. In some embodiments, the second optical element 2115 includes a prism that varies in thickness along at least a radial direction. In some embodiments, the second optical element 2115 includes a wedge angle prism.

In some embodiments, the scanning module 2102 also includes a third optical element (not shown) and a driver for driving the third optical element to move. For example, the third optical element includes a pair of opposing non-parallel surfaces through which the light beam passes. In some embodiments, the third optical element includes a prism that varies in thickness along at least a radial direction. In some embodiments, the third optical element includes a wedge angle prism. At least two of the first, second, and third optical elements rotate at different rotation speeds and/or rotation directions.

Each optical element in the scanning module 2102 can rotate to project light to different directions, such as directions of projected light 2111 and projected light 2113, so that a space around the ranging device 2100 is scanned. When the projected light 2111 projected by the scanning module 2102 hits a detected object 2101, part of the light is reflected back by the detected object 2101 to the ranging device 2100 in a direction opposite to the projected light 2111. Reflected light 2112 reflected back by the detected object 2101 is incident to the collimation element 2104 after passing through the scanning module 2102.

The detector 2105 and the transmitter 2103 are arranged on the same side of the collimation element 2104, and the detector 2105 is configured to convert at least part of the reflected light passing through the collimation element 2104 into an electrical signal.

In some embodiments, each optical element is plated with an anti-reflection coating. For example, thickness of the anti-reflection coating is equal to or close to wavelength of the light beam emitted by the transmitter 2103, which can increase intensity of the transmitted light beam.

In some embodiments, a filter layer is plated on an element surface located on beam propagation path in the ranging device, or a filter is provided on the beam propagation path, which is configured to at least transmit wavelength band of the beam emitted by the transmitter and reflect other wavelength bands, so as to reduce noise caused by ambient light to receiver.

In some embodiments, the transmitter 2103 may include a laser diode, and emit a nanosecond level laser pulse through the laser diode. Further, laser pulse receiving time can be determined, for example, by detecting rising edge time and/or falling edge time of an electrical signal pulse. As such, the ranging device 2100 can calculate time of flight (TOF) using pulse receiving time information and pulse sending time information, so as to determine the distance between the detected object 2101 and the ranging device 2100.

The distance and orientation detected by the ranging device 2100 can be used for remote sensing, obstacle avoidance, surveying and mapping, modeling, navigation, etc. In some embodiments, the ranging device according to the embodiments of the present disclosure can be applied to a mobile platform, and the ranging device can be mounted at a platform body of the mobile platform. The mobile platform with the ranging device can measure external environment, for example, to measure distance between the mobile platform and an obstacle for obstacle avoidance and other purposes, and to perform two-dimensional or three-dimensional surveying and mapping of the external environment. In some embodiments, the mobile platform includes at least one of an unmanned aerial vehicle, a car, a remote control vehicle, a robot, or a camera. When the ranging device is applied to an unmanned aerial vehicle, the platform body is a vehicle body of the unmanned aerial vehicle. When the ranging device is applied to a car, the platform body is a vehicle body of the car. The car can be a self-driving car or a semi-self-driving car, which is not limited here. When the ranging device is applied to a remotely controlled vehicle, the platform body is a vehicle body of the remote control vehicle. When the ranging device is applied to a robot, the platform body is the robot. When the ranging device is applied to a camera, the platform body is the camera itself.

The technical terms used in the embodiments of the present disclosure are only used to describe specific embodiments and are not intended to limit the present disclosure. As used herein, the singular forms “a,” “an,” and “the” are used to include the plural forms as well, unless the context clearly indicates otherwise. Further, the terms “include” and/or “including” used in the specification refer to the presence of the described features, integers, steps, operations, elements, and/or components, but do not exclude the presence or addition of one or more other features, integers, steps, operations, elements, and/or components.

The corresponding structures, materials, actions, and equivalents (if any) of all devices or steps and functional elements in the appended claims are intended to include any structure, material, or action for performing the function in combination with other explicitly claimed elements. The description of the present disclosure is presented for the purpose of examples and description, but is not intended to be exhaustive or to limit the present disclosure to the disclosed form. Various modifications and variations will be apparent to those skilled in the art without departing from the scope and spirit of the present disclosure. The embodiments described in the present disclosure can better disclose the principles and practical applications of the present disclosure, and enable those skilled in the art to understand the present disclosure.

The flow chart described in the present disclosure is only an embodiment, and various modifications and changes can be made to the chart or the steps in the present disclosure without departing from the spirit of the present disclosure. For example, these steps can be performed in a different order, or some steps can be added, deleted, or modified. Those skill in the art can understand that implementing of all or part of the processes of the embodiments described above and equivalent changes made in accordance with the claims of the present disclosure still fall within the scope of the present disclosure.

What is claimed is:

1. A ranging device comprising:
a transmission assembly configured to emit an optical pulse sequence;
a reception assembly configured to receive at least part of the optical pulse sequence reflected back by an object;
an optical path changing element configured to combine transmitting optical path of the transmission assembly and reception optical path of the reception assembly;
a collimation element configured to collimate transmitting light beam of the transmission assembly and converge the at least part of the optical pulse sequence reflected back by the object to the reception assembly; and
a fixing assembly configured to fix the transmission assembly, the reception assembly, the optical path changing element, and the collimation element to each other;
wherein:
the transmission assembly and/or the reception assembly, and the fixing assembly are fixed to each other in at least a first fixing mode and a second fixing mode, a fixed speed in the first fixing mode being higher than that in the second fixing mode, and a fixed strength in the second fixing mode being higher than that in the first fixing mode.

2. The ranging device of claim 1, wherein, when the transmission assembly and/or the reception assembly, and the fixing assembly are fixed to each other in the first fixing mode,
at least one gasket is arranged between the transmission assembly and/or the reception assembly, and the fixing assembly, and the transmission assembly and/or the reception assembly, the fixing assembly, and the at least one gasket are fixed to each other by screws.

3. The ranging device of claim 1, wherein, when the transmission assembly and/or the reception assembly, and the fixing assembly are fixed to each other in the first fixing mode,
movable clamping jaws are configured at the fixing assembly, and the movable clamping jaws are configured to clamp the transmission assembly and/or the reception assembly.

4. The ranging device of claim 1, wherein, when the transmission assembly and/or the reception assembly, and the fixing assembly are fixed to each other in the first fixing mode,
at least portion of a gap between the transmission assembly and/or the reception assembly, and the fixing assembly is filled with a structural adhesive to fix each other.

5. The ranging device of claim 1, wherein, when the transmission assembly and/or the reception assembly, and the fixing assembly are fixed to each other in the first fixing mode,
the fixing assembly includes protruding structures disposed in openings of the transmission assembly and/or the reception assembly, and at least portion of a gap between the protruding structures and the openings is filled with a structural adhesive.

6. The ranging device of claim 1, wherein, when the transmission assembly and/or the reception assembly, and the fixing assembly are fixed to each other in the second fixing mode,
the transmission assembly and/or the reception assembly, and the fixing assembly are fixed to each other by a reinforced structural adhesive.

7. The ranging device of claim 6, wherein, when the transmission assembly and/or the reception assembly, and the fixing assembly are fixed to each other by the reinforced structural adhesive,
at least portion of a gap between the transmission assembly and/or the reception assembly, and the fixing assembly is filled by the reinforced structural adhesive.

8. The ranging device of claim 6, wherein, when the transmission assembly and/or the reception assembly, and the fixing assembly are fixed to each other by the reinforced structural adhesive:
the fixing assembly includes protruding structures, and the transmission assembly and/or the reception assembly contain openings;
the protruding structures are inserted into the openings, and gaps between the protruding structures and the openings are filled by the structural adhesive; and
at least portion of gaps between the transmission assembly and/or the reception assembly, and the fixing assembly are filled by the reinforced structural adhesive.

9. The ranging device of claim 6, wherein, when the transmission assembly and/or the reception assembly, and the fixing assembly are fixed to each other by the reinforced structural adhesive:
the fixing assembly has protruding structures, and a circuit board in the transmission assembly and/or the reception assembly has openings;
the protruding structures are inserted into the openings, and gaps between the protruding structures and at least portion of the openings are filled by the structural adhesive; and
gaps between the protruding structures and at least part of the openings are filled by the reinforced structural adhesive.

10. The ranging device of claim 6, wherein the reinforced structural adhesive includes a gypsum.

11. The ranging device of claim 1, wherein the transmission assembly includes transmission elements electrically coupled to a transmission circuit board, and the reception assembly includes reception elements electrically coupled to a reception circuit board.

12. The ranging device of claim 11, wherein:
the transmission assembly includes a fixed connection or a flexible connection between the transmission elements and the transmission circuit board; and/or
the reception assembly includes a fixed connection or a flexible connection between the reception elements and the reception circuit board.

13. The ranging device of claim 12, wherein for the fixed connection:
pins of the transmission element and the transmission circuit board are fixedly welded; and/or
pins of the reception element and the reception circuit board are fixedly welded.

14. The ranging device of claim 12, wherein pins of each of the transmission assembly and/or the reception assembly include flexible materials, and for the flexible connection:
the pins of the transmission assembly are in elastic contact with metalized holes of the transmission circuit board; and/or
the pins of the reception assembly are in elastic contact with metalized holes of the reception circuit board.

15. The ranging device of claim 12, wherein pins of the transmission assembly and/or the reception assembly include flexible materials, and for the flexible connection:
the pins or pin extension wires of the transmission assembly and metalized holes of the transmission circuit board are welded; and/or
the pins or pin extension wires of the reception assembly and metalized holes of the reception circuit board are welded.

16. The ranging device of claim 1, wherein the collimation element is located at one end of the fixing assembly, the reception assembly is located at an other end of the fixing assembly, and the at least part of the optical pulse sequence reflected back by the object forms an optical path between the transmission assembly and the collimation element.

17. The ranging device of claim 1, wherein the collimation element is located at one end of the fixing assembly, and the transmission assembly is located at a side of the fixing assembly.

18. The ranging device of claim 1, wherein the optical path changing element is located within the fixing assembly, and the transmission assembly transmits emitted optical pulse sequence to the collimation element within the fixing assembly through the optical path changing element.
